(19) United States
(12) Patent Application Publication
(10) Pub. No.: US 2011/0041070 A1
(43) Pub. Date: Feb. 17, 2011

(54) OPERATING SYSTEM AND METHOD FOR MAKING RESOURCES AVAILABLE VIA A COMPUTER SYSTEM

(76) Inventor: Robin Knijn, Westmalle (BE)

Correspondence Address: Steinfl & Bruno, 301 N Lake Ave Ste 810, Pasadena, CA, 91101, US

(21) Appl. No.: 12/863,587

(22) PCT Filed: Jan. 19, 2009
(86) PCT No.: PCT/IB2009/000077

§ 371 Date: Oct. 8, 2010

Related U.S. Application Data
(60) Provisional application No. 61/022,376, filed on Jan. 21, 2008.

(30) Foreign Application Priority Data
Jan. 21, 2008 (NL) 1034937

(51) Int. Cl. G06F 3/048

(52) U.S. Cl. 715/739

(57) ABSTRACT

The present invention relates to an operating system for a computer system connected to a telecommunication network, the operating system comprising selection display means arranged for displaying the resources. The resources comprise network resources which are accessible via the telecommunication network and system resources which are accessible via the computer system. The operating system further comprises means for receiving a resource selection and means for making the resources available dependent on the received selection. The selection display means are arranged for displaying selectable resource classes and for displaying within each of the resource classes resources belonging to that resource class. The operating system further comprises means for having the computer system autonomously classify each of the resources under one or more resource classes, and means for maintaining a classification of resources under the one or more resource classes.

The present invention relates to an operating system for a computer system connected to a telecommunications network, the operating system comprising selection display means arranged for displaying resources, the resources comprising network resources which are accessible via the telecommunications network and system resources which are accessible via the computer system, the operating system further comprising means for receiving a resource selection and means for making the resources available dependent on the received selection. The invention further relates to a computer system, and a data carrier containing the operating system.

The invention further relates to a method for making available resources through a computer system connected to a telecommunications system, the resources comprising network resources which are accessible via the telecommunications network and system resources which are accessible via the computer system, the method comprising the steps of displaying resources, receiving a resource selection and, in response to the received selection, making the resources available in dependence on the received selection.

It is impossible to imagine life today without the use of computer systems and the internet. In each house and in each building today one will find one or more computer systems which are connected to the internet. Since the use of computer systems has expanded enormously in the eighties and nineties of the twentieth century, and the lack of experience with them has stood in the way of the accessibility of computer systems, especially in the early years the use of computer systems and the internet was dominated by young users who made their acquaintance already at school and at university. It has cost more time for older generations to familiarize themselves with computer skills, but eventually the use of computer systems and the internet is no longer restricted to certain sections of the community.

Although the operating systems are ever more aimed at the user-friendliness of the applied user interfaces, the many options of a computer system and the internet as well as the required skills to properly implement these options continue to stand in the way of an efficient use of computer systems. Therefore, there are still many people and even users of computer systems who lack the skills of making efficient use the computer system, and there is still a substantial group of people who would rather avoid using computers or do not even make use of them at all. Of all people of 65 years and older and of all low educated youngsters under the age of 18, no less than 66% does not use a computer(system). The lack of knowledge and the fear of unfamiliar operations are the most important reasons thereof.

Therefore, there is a need for an operating system for a computer system for which the user's intuition is sufficient to utilize all its possibilities. Although there is widespread use of pictograms in operating systems, such as Microsoft Windows™, Linux™ etc., and also internet environments can be fully integrated with the user interfaces of such operating systems, these operating systems insufficiently cater for the need mentioned hereinbefore. Computer skills for using these operating systems are required to an appreciable extent. Starting from specific wishes of a user at a certain moment, the user should determine by himself which applications or resources of the computer system and/or the internet should be used so as to be able to meet his wishes. This process is not intuitive but requires knowledge about the available resources and a rationally reasoned selection on the part of the user. Nor is gaining access to these resources self-evident despite all the search engines.

The object of the present invention is to provide a fully intuitive operating system for a computer system with which tailor-made resources can be made available to the user.

This and further objects are achieved by the present invention in that the invention provides an operating system for a computer system connected to a telecommunications network, the operating system comprising selection display means arranged for displaying resources, the resources comprising network resources which are accessible via the telecommunications network and system resources which are accessible via the computer system, the operating system further comprising means for receiving a resource selection and means for making the resources available in dependence on the received selection, the selection display means being arranged for displaying selectable resource classes and for displaying within each of the resource classes resources belonging to that resource class, the operating system further comprising means for having the computer system autonomously classify each of the resources under one or more resource classes, and means for maintaining a classification of the resources under the one or more resource classes.

The intuitive operating system according to the invention autonomously classifies the available resources into classes, which resource classes enable the user to intuitively aim at those resources that can most efficiently meet his wishes. The resources can be classified under one or more resource classes. For example, a resource that is classified under a plurality of resource classes can be easily found by the user under a plurality of subject classes.

The above may be elucidated by means of a simple example. A person who wants to cook a nice dinner at home may find for example recipes in his resource class ‘personal environment’ under the sub-class ‘home and garden’. Relevant information about nutritional values and recipes may also be found under the sub-class ‘health’. Yet another class under which recipes may be found is, for example, the class ‘leisure time’. Restaurants in their turn are to be found under ‘personal world’ and ‘evening out’, but also under ‘professional world’, then ‘relation management’ and then under ‘luncheon facilities’. Restaurants may also be found under for example ‘travelling’ and ‘city breaks’. Therefore, this is a decision tree structure with dynamic links (the same information to be found back under a plurality of different resources).

Here is another example. If the user has been through something spectacular and wants to share it with for example a friend, the user may start up his computer system in search for an e-mail programme to send an e-mail. The user will then search for the right resource class dealing with communication and thus find the e-mail programme. If the user is searching for example a domestic appliance and wishes to receive additional information about a product shown on the Internet, the user, when searching for the domestic appliance, may have landed in the resource class ‘products and services’. Within the resource class ‘products and services’ he will find for example a sub-class ‘product information’, and when choosing this sub-class the user has for example the option of opening his e-mail programme.

The resources may be selected from a group comprising information resources for supplying a user with information, auxiliary resources such as computer programmes for executing data processing and computer tasks, data resources such as databases for supplying a user with data. The operating system is restricted not only to for example internet resources, nor to only computer system resources, but makes resources of both types available to the user in one homogeneous way. Therefore, it is no longer necessary for the user to leave the internet browser and search for another programme when certain tasks are to be executed. The user simply has access to all resources that are found within the resource class.

According to a preferred embodiment the means for making the resources available are arranged for making the resources available on a user-dependent basis. Each user has his own preferences and wishes and an intuitive classification of resources which is logical to one user need not necessarily be logical to the other user. Therefore, the invention provides a possibility to make the classification of resources under resource classes user-dependent, which classification is autonomously carried out by the computer system. To this end the classification of resource classes can for example continuously be updated by the computer system in dependence on changes in the user's behaviour, if for example he always prefers the telephone for communication with friends and acquaintances, for example ‘internet telephony’ will then be at the top in the resource class ‘communication’. If this user rarely uses a chat box for communication, for example chat programmes may be classified under the resource class ‘other communication means’ which may then be a sub-class of the main class ‘communication’. For example, it may also happen that one user places services made by for example a masseur under ‘health’ because he regularly uses physiotherapeutic help or masseurs for example as a consequence of musculoskeletal discomfort, whereas another user wants to find masseurs under ‘recreation’.

This user-dependent classification can be updated in the operating system and more particularly the means for classifying the resources are arranged for classifying these resources on a user-dependent basis, as already mentioned hereinbefore. If a classification made by the operating system is not experienced to be logical by the user, the user is obviously offered the possibility to modify this classification made by the operating system of his own volition.

According to a further embodiment the operating system, and more particularly the means for making the resources available, are arranged for making resources user-dependent or blocking them or making them available. For example the case may be that certain resources are not child-friendly and as a result can be closed down to for example children by means of a time lock, personal login or fixed setting.

The means for making the resources available may be arranged not only for making the resources available on a user-dependent basis, but the case may also be that the resources are made available on a time-dependent basis. The following example may be given. Suppose a user is working at a financial institution. When the user rises in the morning and turns on his computer, it may happen that the resource class ‘news and information’ is prominently displayed on his screen. The user has for example contracted the habit of verifying each morning what has happened in the world. In that case and depending on the day of the week and the time of day, the computer system can give the resource class ‘news and information’ a higher or lower hierarchical priority. In lieu of or in addition to prioritising, certain resources can also be made accessible on a time-dependent basis. If this same user turns on his computer system at eleven o'clock in the morning on for example a Tuesday, the user may get a view of quite another classification which is completely tuned for example to his work environment. He may then witness the resource classes ‘work and economy’, ‘economy’, ‘documents and word processing’ etc. If the same user then at nine o'clock in the evening turns on his computer system, the classification provided by the operating system may entirely be tuned to for example ‘recreation and entertainment’.

The time dependence may have been selected from a group containing dependence on a time of day, a month of a year, a season, a year, and a user's age. More particularly the means for classifying the resources are arranged for providing the time-dependent classification or accessibility of each of the resources under one or more resource classes. This classification can be stored in for example the internal memory of the computer system.

The user can make known his choice in various regular ways, for example by means of the mouse, the keyboard, speech or other input methods.

According to a second aspect the invention provides a computer system comprising the operating system described hereinbefore. Furthermore, according to a third aspect, the invention provides a data carrier containing the operating system as described hereinbefore.

According to a fourth aspect the invention provides a telecommunication system in which the resources comprise network resources which are accessible via the telecommunication network and system resources which are accessible via the computer system, the system comprising the steps of: displaying resources; receiving a resource selection; and in response to the received selection, making the resources available in dependence on the received selection; while the displaying step comprises the displaying of selectable resource classes and within each of the resource classes displaying resources belonging to that resource class; the method further comprising the steps of: having the computer system autonomously classify each of the resources under one or more resource classes; and updating a classification of the resources under the one or more resource classes.

The invention will be elucidated more fully below based on specific embodiments not intended to be restrictive while reference is made to the appended drawing Figures, in which:

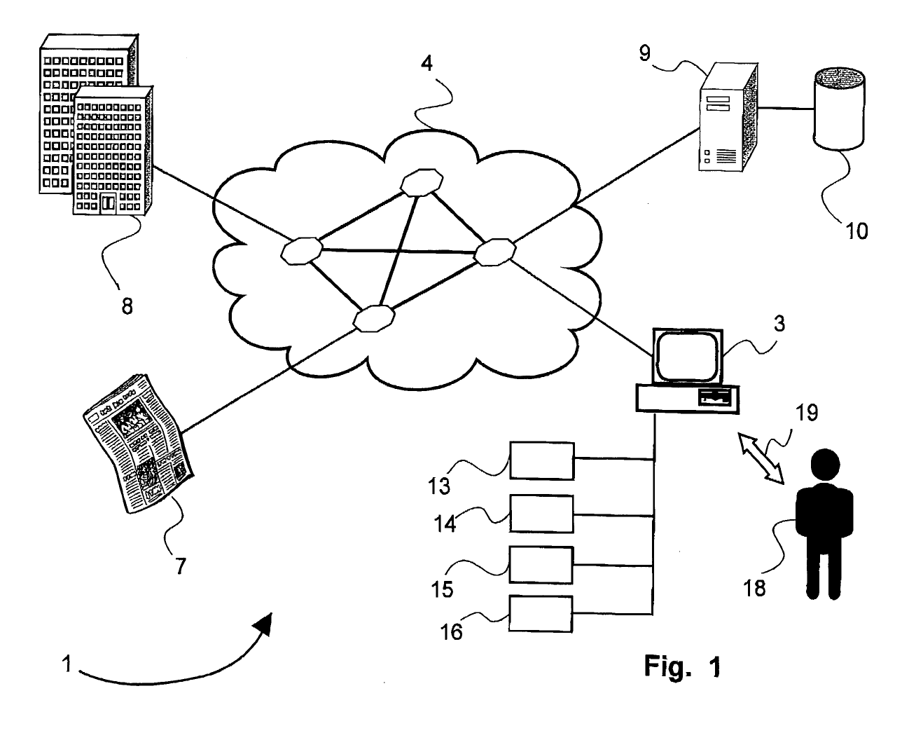

FIG. 1 shows an environment in which the operating system and the method according to the invention can be applied;

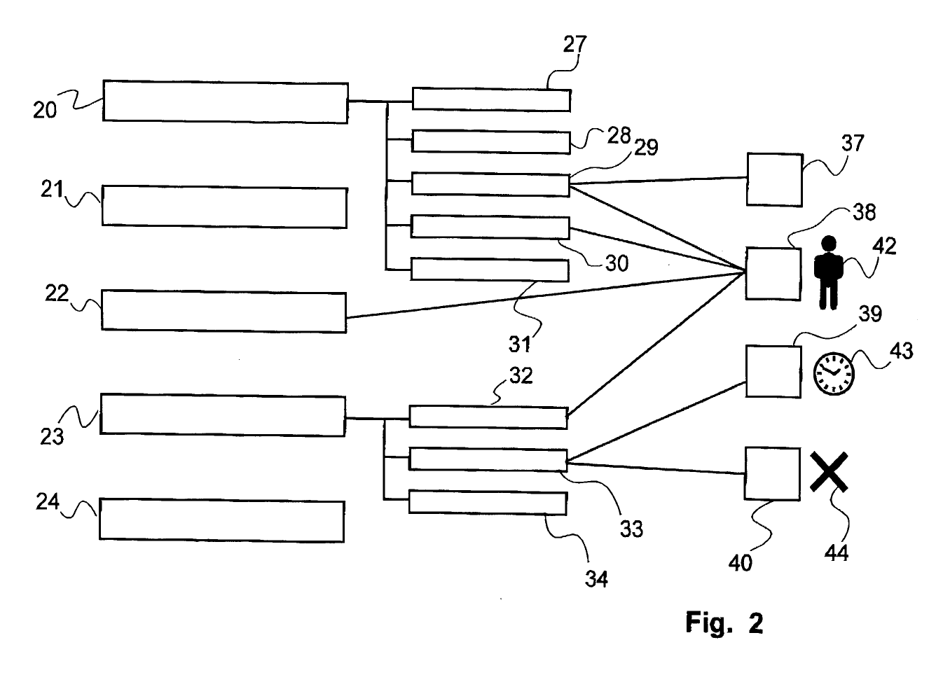

FIG. 2 shows an example of a classification used by an operating system according to the present invention;

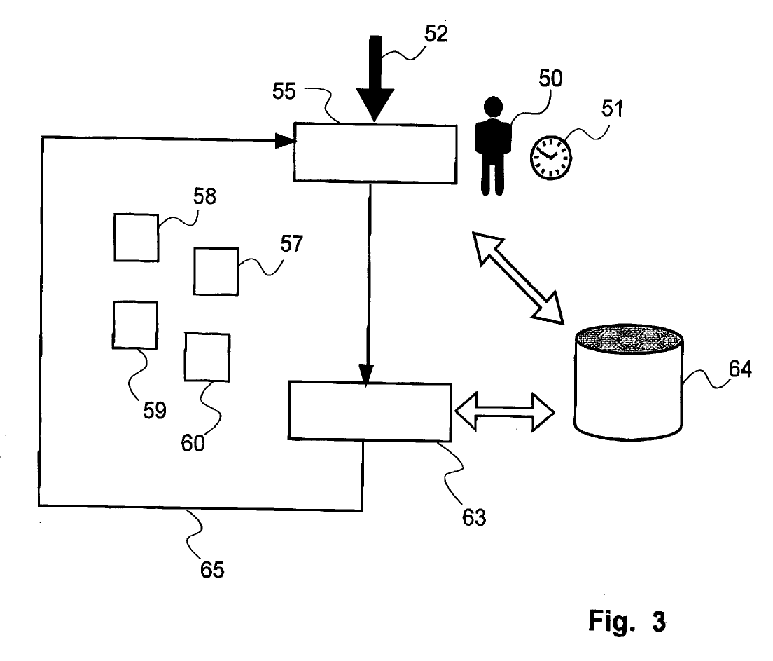

FIG. 3 shows an internal procedure in the operating system with which the resource class classification can be adapted.

FIG. 1 shows diagrammatically an environment (generally referred to by reference numeral 1) in which the operating system according to the present invention can be applied. The environment 1 comprises a computer system 3 which is connected to a telecommunication network 4, such as for example the internet. Those of skill in the art will understand that the invention is not restricted to the connecting of the computer system 3 to the Internet, but that also connecting to other telecommunication networks is possible.

Via the telecommunication network 4 can be obtained access to a large number of different resources such as for example topical news and information, shown diagrammatically by newspaper 7, economically related resources 8, servers 9 which are linked or not to data bases such as data base 10 etc. In addition, via computer system 3 are available various auxiliary resources such as communication software 13, data processing software 14, internet browser 15 and for example user data 16.

Computer system 3 is internally controlled by an operating system according to the present invention (not shown in the diagram). User 18 can interact (shown by reference numeral 19 in the drawing Figure) with computer system 3 by means of various input means known to those skilled in the art such as a keyboard, a mouse, speech recognition etc.

In an intuitive manner the operating system according to the invention makes the various resources 7, 8, 9 and 10 available which are accessible via the telecommunication network 4, as well as the resources 13, 14, 15 and 16 which can locally be used/consulted on computer system 3. To this end the operating system uses a resource class classification in which each of the resources is classified under at least one resource class. The user 18 who logs on to the computer system 3 is shown the resource class classification based on personal preference and settings and can make a choice based on the visible categories so as to end up at the available resources 7-16 via a hierarchical classification system.

An example of a resource class classification is shown diagrammatically in FIG. 2. FIG. 2 shows a plurality of main classes 20, 21, 22, 23, 24. The classification under main classes may be tuned to the wishes of the user and the invention is not restricted to a specific classification of classes. A possible classification of main classes may comprise for example ‘personal environment’, ‘work-related environment’. ‘sociery and world’, ‘updates’, etc.

Within each of the main classes there may be a subdivision of sub-classes such as for example for main class 20 which is subdivided into sub-classes 27, 28, 29, 30 and 31. The main resources as well as the sub-resources depend on personal settings and preferences.

Assuming that for example main class 20 is meant for a user's personal environment, the subdivision of main class 20 can consist of for example the categories ‘relations’, ‘lifestyle’, ‘health’, ‘sexuality’, ‘education’, ‘communication’, ‘transport’, ‘products and services’, ‘software, files and favourites’, ‘system settings’, ‘finances’, ‘leisure time’, ‘house and garden’, ‘computers’, ‘entertainment’. Needless to say that this classification is quite arbitrary and may be chosen at random.

A hierarchical classification which may serve as an example will be given hereinbelow (textual indent levels indicate main classes and sub-classes in this (non-restrictive) example):

Personal Environment
Relations
Lifestyle
Health
Sexuality
Education
Communication
Transport
Products and services
Software, files and favourites
System settings and parental supervision
Investments and savings
Leisure time
House and garden
Computers
Entertainment

Business Environment
Work and career
Investments and savings
Economy
Transport
Communication
Products and services
Software, files and favourites
Industry specifics
Education
Computers
Business update

General Environment
Nature, climate and environment
Countries
Medical services
Public services
Education
Cultures
History
Religion and spirituality
Politics
Non-profit
Community

Update
News
Current traffic announcements
The weather
Sports
Trends
Horoscope
Lottery results
Missed calls and e-mail
Notifications
   Further subdivision of the resource classes can provide a specific survey of related classes for the resource class involved. The interpretation of the resource classes can be determined based on regional information, automatically generated content and personal additions, preferences and settings. Each resource class may contain links to resources as well as further resource classes for further specifications within subjects or categories. There may also be short-cuts to resource classes at higher levels. Links to resources may be visualised by miniature images or icons. If need be, special attention may be given by means of moving images to the resource or, for example, to advertisers who are active within a subject category.

FIG. 2 further shows a plurality of resources 37, 38, 39 and 40. The resources are classified under different resource classes. Resource 37, for example, may be an information resource, for example the website of a medical insurance company and may be made available in sub-class 29 (for example ‘health’) within main class 20 (for example ‘personal environment’). A resource such as resource 38 may also be placed in a plurality of sub/classes. Resource 38 may for example be an e-mail client who has access to a plurality of sub and main classes as is shown in FIG. 2, sub-classes 29 and 30 of main class 20, sub-class 32 of main class 23 and main class 22.

FIG. 2 shows diagrammatically by means of the user indicator 42 that the availability of the resource in the various classes can be user-dependent. One user will for example prefer using e-mail as a result of which resource 38 may be an e-mail client, whereas another user prefers using the telephone as a result of which resource 38 may be a telephone communication programme over the internet. Furthermore, also the classification under the various classes may be made dependent on the user. For example, the case may be that an e-mail client 38 is preferably used for correspondence to institutions such as a medical insurance company, a bank etc., whereas the same user prefers just different communication means in his communications to friends and acquaintances. This may be represented in the user-dependent classification of resources.

Resource 39 is a resource that is made available to the user only on a time-dependent basis. For example, resource 39 may be a server on which sexual entertainment can be downloaded. A resource of this type is consulted by a user for example only in the evenings and the user is not interested in consulting this resource while he is at work during the day. This is shown diagrammatically in FIG. 2 by means of the clock indicator 43.

Resource 40 may be blocked to the user because it has content that is unsuitable for the user. For example if the user is a minor, it may be that parents or guardians of this user do not wish resource 40 (for example an on line casino) to be available to the underaged user. This is shown diagrammatically in FIG. 2 by means of a cross 44.

FIG. 3 further shows an internal method in the operating system, which method provides that the classification of resources can be adapted on a dynamic and user-dependent basis. In FIG. 3 a user 50 logs on to a computer system at time 51, which is shown diagrammatically by the black arrow 52. In step 55 the user consults various resources consisting of information resources on for example a telecommunication network and in computer programmes available on the computer system. These resources are shown diagrammatically by blocks 57, 58, 59 and 60. Resources 58 and 57 are standard resources which are continuously consulted by user 50 at for example, fixed times of day. Based on experience with the user resources 57 and 58 are classified under various resource classes and this classification is stored in the memory 64 of the computer system. Resource 59 is a new information resource consulted by the user 50.

In the classification step 63 the new information resource 59 is recognised as a new information resource which is to be classified under a resource class. Based on the content available via the information resource, it can be classified under a resource class by the computer system in step 63, which resource class is stored in the memory 64. More particularly, use can be made of an analysing system which analyses the data available via resource 59 and makes a classification based on this analysis. This may be effected for example based on keywords or by means of a similar analysis method. Various simple analysis methods as well as highly ingenious analysis methods are available on the market and can be integrated with the existing operating system so as to be able to make a proper classification of resources.

When a user 50 installs a new computer programme 60 on the computer system, this computer programme 60 is also to be classified in classification step 63. The classification can be effected for example automatically, based on the information about the computer programme 60 supplied by the manufacturer, which may be effected during the installation procedure. It is also possible for the computer system to come interactively with the user 50 to a suitable classification, for example, by asking the user to give a brief description of the installed programme. If the user 50 indicates for example that programme 60 is a word processor, in classification step 63 resource 60 will among other things be classified under the work-related main class, for example under one of the sub-classes.

The method shown in FIG. 3 is dynamic and can take place in the background while the user is using the computer system. This is shown diagrammatically by means of arrow 65 which refers back to step 55 in which the user consults the resources in a normal way. The classification may for example be integrally updated once, during the log on operation 52 of the user 50. It is also possible for the classification to be effected during the use of the computer system. The latter possibility, however, does not have preference because it may become obscure to a user in which class a certain resource has been made available. Alternatively, it is possible that when a resource class is modified a certain resource is temporarily classified under the two resource classes, so that the user finds back the resource in the old familiar resource class as well as in the new resource class which is classified in the classification step 63. Furthermore, it is possible for example when in the case mentioned above the resource in the new resource class is never consulted by the user, that this resource will be omitted from said resource class in the end.

The embodiments shown in the drawings are rather intended for illustrative purposes and are not by any manner or means intended to be restrictive to the invention. The context of the invention discussed here is merely restricted by the spirit and scope of the following claims.

1. An operating system for a computer system connected to a telecommunications network, the operating system comprising selection display means arranged for displaying resources, the resources comprising network resources which are accessible via the telecommunication network and system resources which are accessible via the computer system, the operating system further comprising means for receiving a resource selection and means for making the resources available dependent on the received selection, wherein the selection display means are arranged for displaying selectable resource classes and for displaying within each of the resource classes resources belonging to that resource class, the operating system further comprising means for having the computer system autonomously classify each of the resources under one or more resource classes and means for maintaining a classification of the resources within the one or more resource classes.

2. The operating system according to claim 1, wherein the resources are elements of a group comprising information resources for providing information to a user, auxiliary resources such as computer programmes for executing data processing and computer tasks, data resources such as databases for providing data to a user.

3. The operating system according to claim 1, wherein the means for making the resources available are arranged for making the resources available on a user-dependent basis.

4. The operating system according to claim 3, wherein the means for maintaining the classification are arranged for maintaining a user-dependent classification of the resources.

5. The operating system according to claim 4, wherein the classification means for classifying the resources are arranged for classifying each of the resources under one or more resource classes.

6. The operating system according to claim 3, wherein the means for making the resources available are arranged for either blocking resources or making resources accessible on a user-dependent basis.

7. The operating system according to claim 1, wherein the means for making the resources available are arranged for making the resources available on a time-dependent basis.

8. The operating system according to claim 7, wherein the means for classifying the resources are arranged for providing the time-dependent classification of each of the resources under said one or more resource classes.

9. The operating system according to claim 7, wherein the time dependence is an element of a group comprising dependence on a time of day, a month of a year, a season, a year, and a user's age.

10. The operating system according to claim 1, wherein the means for receiving a resource selection are arranged for receiving the selection by means of at least one input method of a group comprising mouse input, speech input and key input.

11. A computer system comprising the operating system according to claim 1.

12. A data carrier containing the operating system according to claim 1.

13. A method for making resources available via a computer system connected to a telecommunication system, the resources comprising network resources which are accessible via the telecommunication network and system resources which are accessible via the computer system, the method comprising the steps of:
displaying resources;
receiving a resource selection; and,
in response to the received selection, making the resources available in dependence on the received selection;
wherein the displaying step comprises the displaying of selectable resource classes and displaying within each of the resource classes resources belonging to that resource class;
which method further comprises the steps of:
having the computer system autonomously classify each of the resources under one or more resource classes; and
maintaining a classification of the resources in the one or more resource classes.

14. The method according to claim 13, wherein the resources are selected from a group comprising information resources for providing information to a user, auxiliary resources such as computer programmes for executing data processes and computer tasks, data resources such as databases for providing data to a user.

15. The method according to claim 13, wherein the step of making the resources available is arranged for making the resources available on a user-dependent basis.

16. The method according to claim 15, wherein the resources are classified under one or more resource classes on a user-dependent basis.

17. The method according to claim 13, wherein the step of making the resources available is arranged for making the resources available on a time-dependent basis.

18. The method according to claim 17, wherein the dependence on time is selected from a group comprising dependence on a time of day, a month of a year, a season, a year and a user's age.
